(19) United States
(12) Patent Application Publication
(10) Pub. No.: US 2022/0383512 A1
(43) Pub. Date: Dec. 1, 2022

(54) TRACKING METHOD FOR IMAGE GENERATION, A COMPUTER PROGRAM PRODUCT AND A COMPUTER SYSTEM

(71) Applicant: Varjo Technologies Oy, Helsinki (FI)

(72) Inventors: Ville Miettinen, Helsinki (FI); Mikko Ollila, Tampere (FI); Mikko Strandborg, Hangonkylä (FI)

(73) Assignee: Varjo Technologies Oy, Helsinki (FI)

(21) Appl. No.: 17/331,857

(22) Filed: May 27, 2021

(51) Int. Cl. G06T 7/246; G06F 3/01; G02B 27/00

(52) U.S. Cl. CPC G06T 7/246; G06F 3/013; G02B 27/0093; G02B 2027/0138

(57) ABSTRACT

The transmitted information from a gaze tracker camera to a control unit of a VR/AR system can be controlled by an image signal processor (ISP) for use with a camera arranged to provide a stream of images of a moving part of an object in a VR or AR system to a gaze tracking function of the VR or AR system, the image signal processor being arranged to receive a signal from the gaze tracking function indicating at least one desired property of the images and to provide the stream of images to the gaze tracking function according to the signal. The ISP may be arranged to provide the image as either a full view of the image with reduced resolution or a limited part of the image with a second resolution which is high enough to enable detailed tracking of the object.

### TECHNICAL FIELD

The present disclosure relates to a tracking method for use in a virtual reality (VR) or augmented reality (AR) system, a computer program product for performing the tracking method and a computer system in which the method may be performed.

### BACKGROUND

To ensure proper projection of the image, a tracker algorithm is provided for constantly tracking the position of the eye. This tracking function typically receives tracking data from two cameras, one per eye, arranged to track the eyes of the person using the VR/AR system. An image signal processor (ISP) associated with the camera transmits the image data through an IPS pipeline to the tracker subsystem of the VR/AR system. In a typical virtual reality/augmented reality (VR/AR) system each of the tracker cameras runs at, for example, 200 Hz, which means that 200 frames per second are transmitted from each camera to the central processing unit (CPU) of the system.

The transmission of the camera data requires considerable bandwidth and unnecessary computational work on the CPU of the VR/AR system, to crop and bin the tracking data.

### SUMMARY

An object of the present disclosure is to enable tracking of a target in a VR/AR system with reduced tracking overhead.

The disclosure therefore relates to an image signal processor for use with a camera arranged to provide a stream of images of a moving part of an object in a VR or AR system to a gaze tracking function of the VR or AR system, the image signal processor being arranged to receive a signal from the gaze tracking function indicating at least one desired property of the images and to provide the stream of images to the gaze tracking function according to the signal. The disclosure also relates to a camera assembly including such an image signal processor and to an imaging system including such a camera assembly intended for gaze tracking.

The disclosure also relates to a gaze tracking subsystem for use in an AR/VR system arranged to receive images of a moving part of an object in the VR or AT system from a camera and to alternate between a global tracking mode adapted to locate the position of the moving object in an image and a local tracking mode adapted to locate the boundary of the moving object with more detail than the global tracking mode, said gaze tracking subsystem being arranged to provide information to the camera indicating at least one property of the image.

The disclosure also relates to a method of tracking a moveable object in a VR or AR system. Said method comprises the steps of

receiving from a camera an image stream including the movable object,

transmitting tracking information to the camera indicating whether global or local tracking is carried out,

adapting the content of the images of the image stream in dependence of the tracking information.

The disclosure provides a simple and practical method for significantly reducing the bandwidth requirements of tracking cameras, and lowering CPU load of tracking algorithms. The camera ISP pipeline is modified so that only the data actually needed for tracking in a give situation is transmitted to the CPU. In the normal case, the eye moves very little most of the time, so that only a small portion of the image has to be transmitted. This small portion can be transmitted with a high resolution to enable accurate tracking of the object. When the movement is larger, tracking should be enabled in substantially the whole image, but the accuracy requirements are less strict so that a lower resolution is permitted.

This means, that for any given frame either a heavily downsampled (“binned”) image of the entire camera frame buffer or a small moving crop rectangle surrounding the tracked object is transmitted. This is achieved according to the present disclosure by making the ISP aware of this, and making sure that it will send only the necessary data. All the relevant information from the tracker will be sent to the ISP in terms that are commonly supported by ISPs, in particular, binning and crop rectangles. This is in contrast to prior art systems, in which the tracking data are transmitted as raw signals, meaning that the entire camera image is transmitted for every frame.

### BRIEF DESCRIPTION OF DRAWINGS

Embodiments of the present disclosure will now be described, by way of example only, with reference to the following diagrams wherein:

FIG. 1 shows an example VR/AR system implementing methods according to the invention; and

FIG. 2 is a flow chart of a method according to embodiments of the invention

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The invention relates to the communication between the tracker camera and the tracking subsystem of the VR/AR system. The tracker camera is typically included in a headset worn by the user of the system and is arranged to provide a stream of images of a moving part of an object in a VR or AR system to a gaze tracking function of the VR or AR system. The headset also includes the functions for projecting the VR/AR image to the user. Image processing, and gaze tracking, are performed in a logic unit, or control unit, which may be any suitable type of processor unit and is often a standard computer such as a personal computer (PC).

The tracker camera is associated with an image signal processor, which according to the invention is arranged to receive a signal from the gaze tracking function indicating at least one desired property of the images and to provide the stream of images to the gaze tracking function according to the signal. In this way, only the relevant part of the images to be used in gaze tracking may be transmitted to the gaze tracking function, which means that the communication from the headset to the control unit can be significantly reduced. The image signal processor may be arranged to provide the image as either a full view of the image with reduced resolution or a limited part of the image with a second resolution which is high enough to enable detailed tracking of the object. The image signal processor may be arranged to provide the limited part of the image as a small moving crop rectangle surrounding the tracked object.

According to the present disclosure, the camera end of the camera ISP pipeline is modified to be in synchronization with the actual requirements of our internal tracking algorithms. For example, in gaze tracking our average actual requirement per frame may be a 120×100 pixel crop rectangle of the camera input. The camera is preferably arranged to image at least a part of a face of a user of the VR or AR system, the part including at least one eye of the user as the moving part. A camera assembly may include a gaze tracking camera and an image signal processor arranged to control the communication between the camera assembly and the control unit of the VR/AR system so that the amount of data to be transmitted can be reduced as discussed above.

A gaze tracking subsystem for use in a VR/AR system accordingly is arranged according to the invention, in the control unit of the VR/AR system, to receive images of a moving part of an object in the VR or AT system from a camera and to alternate between a global tracking mode adapted to locate the position of the moving object in an image and a local tracking mode adapted to locate the boundary of the moving object with more detail than the global tracking mode, said gaze tracking subsystem being arranged to provide information to the camera indicating at least one property of the image. As indicated above, the information preferably indicates that the image should be provided as either a full view of the image with reduced resolution or a limited part of the image with a second resolution which is high enough to enable detailed tracking of the object.

A method of performing tracking of a movable object according to embodiments of the invention includes the steps of
receiving from a camera an image stream including the movable object,
transmitting tracking information to the camera indicating whether global or local tracking is carried out, and
adapting the content of the images of the image stream in dependence of the tracking information.

The method may further comprise performing local tracking of markers on the movable object based on the image stream, and if the movable object is no longer detected in the image stream, changing from local tracking to global tracking to determine the position of the movable object in the image stream.

In some embodiments the method involves adapting the content in such a way that a full image with reduced resolution is transmitted if the tracking information indicates that global tracking is carried out, and a part of the image comprising the tracked object with sufficient resolution to enable detailed tracking of the object is transmitted if the tracking information indicates that local tracking is carried out. The tracking information may also indicate that local tracking is carried out includes information about which part of the image comprises the tracked object.

### DETAILED DESCRIPTION OF DRAWINGS

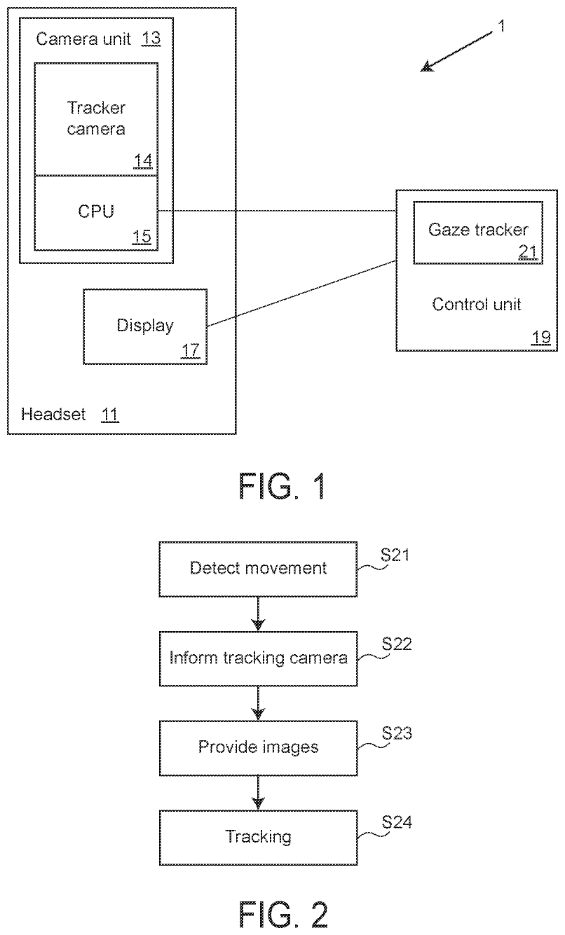

FIG. 1 shows schematically a VR/AR system 1 including a headset 11 intended to be worn by a user. The headset 11 includes a tracker camera unit 13 comprising a camera 14 and an image signal processing unit ISP 15 for the camera. The headset 11 also includes display functions 17 for projecting an image stream to be viewed by the user. The headset is connected to a control unit 19 which includes a gaze tracking function 21 and image processing functions. The image processing functions are performed in any suitable way, including based on the tracking function 21, but will not be discussed in more detail here. The control unit 19 may for example be implemented in a personal computer or similar. The ISP 15 is arranged to control the image data transmitted from the tracker camera to the CPU of the VR/AR system.

The control of the image data is performed by the ISP 15 in accordance with a request received from the tracking function of the VR/AR system, which is implemented in the control unit 19 as discussed above.

FIG. 2 is a flow chart of a method that may be used for tracking markers in an image stream. In a first step S21 the gaze tracking function in the control unit of the VR/AR system detects, based on the movement of the eye, the type of images it should receive from the tracking camera, and in step S22 it informs the tracking camera about this. Typically, as discussed above, this involves, if the detected movement of the tracked object is small, that a small portion of the whole image, including the tracked object, and with a high resolution, should be received. Similarly, if a larger movement of the tracked object is detected, substantially the whole image field of view should be received, to enable tracking of the object within the image. Since less accuracy is required for this tracking, the whole image could be transmitted with a lower resolution. In step S23, ISP provides the stream of images from the tracker camera to the tracking function, according to the request received in step S21. In step S24, tracking is performed based on the received image data.

According to this disclosure, therefore, the amount of data that needs to be transmitted from the ISP 15 of the headset 11 to the control unit 19 is significantly reduced.

1. An image signal processor for use with a camera arranged to provide a stream of images of a moving part of an object in a VR or AR system to a gaze tracking function of the VR or AR system, the image signal processor being arranged to receive a signal from the gaze tracking function indicating at least one desired property of the images and to provide the stream of images to the gaze tracking function according to the signal.

2. An image signal processor according to claim 1, arranged to provide the image as either a full view of the image with reduced resolution or a limited part of the image with a second resolution which is high enough to enable detailed tracking of the object.

3. An image signal processor according to claim 1, wherein the camera is arranged to image at least a part of a face of a user of the VR or AR system, the part including at least one eye of the user as the moving part.

4. An image signal processor according to claim 1, arranged to provide the limited part of the image as a small moving crop rectangle surrounding the tracked object.

5. A camera assembly, including a camera an an image signal processor according to claim 1.

6. A VR or AR system including an image signal processor comprising a camera assembly according to claim 5.

7. A gaze tracking subsystem for a VR or AR system arranged to receive images of a moving part of an object in the VR or AT system from a camera and to alternate between a global tracking mode adapted to locate the position of the moving object in an image and a local tracking mode adapted to locate the boundary of the moving object with more detail than the global tracking mode, said gaze tracking subsystem being arranged to provide information to the camera indicating at least one property of the image.

8. A gaze tracking subsystem according to claim 7, wherein the information indicates that the image should be provided as either a full view of the image with reduced resolution or a limited part of the image with a second resolution which is high enough to enable detailed tracking of the object.

9. A VR or AR system including a gaze tracking subsystem according to claim 8.

10. A method of performing tracking of a movable object in a VR or AR system, comprising
receiving from a camera an image stream including the movable object,
transmitting tracking information to the camera indicating whether global or local tracking is carried out,
adapting the content of the images of the image stream in dependence of the tracking information.

11. A method according to claim 10, further comprising
performing local tracking of markers on the movable object based on the image stream,
if the movable object is no longer detected in the image stream, changing from local tracking to global tracking to determine the position of the movable object in the image stream.

12. A method according to claim 10, wherein the content is adapted in such a way that a full image with reduced resolution is transmitted if the tracking information indicates that global tracking is carried out, and a part of the image comprising the tracked object with sufficient resolution to enable detailed tracking of the object is transmitted if the tracking information indicates that local tracking is carried out.

13. A method according to claim 12, wherein the tracking information indicating that local tracking is carried out includes information about which part of the image comprises the tracked object.
